(19) United States
(12) Patent Application Publication
(10) Pub. No.: US 2013/0308567 A1
(43) Pub. Date: Nov. 21, 2013

(54) METHODS AND APPARATUS FOR POSITIONING REFERENCE SIGNALS IN A NEW CARRIER TYPE

(71) Applicant: QUALCOMM Incorporated, San Diego, CA (US)

(72) Inventors: Wanshi Chen, San Diego, CA (US); Peter Gaal, San Diego, CA (US); Yongbin Wei, San Diego, CA (US)

(73) Assignee: QUALCOMM Incorporated, San Diego, CA (US)

(21) Appl. No.: 13/894,182

(22) Filed: May 14, 2013

Related U.S. Application Data
(60) Provisional application No. 61/647,475, filed on May 15, 2012.

(51) Int. Cl. H04W 72/04

(52) U.S. Cl. CPC H04W 72/0453
USPC 370/329

(57) ABSTRACT

Certain aspects of the present disclosure relate to methods and apparatus for positioning reference signals (PRS) in a new carrier type (NCT). A UE (user equipment) may identify a carrier type in which PRS will be transmitted and may determine a pattern for the PRS based on the identified carrier type. For example, different PRS patterns may be used for legacy and new carrier types. Similarly, a base station (BS) may determine a pattern for the PRS based on identifying a carrier type in which the PRS will be transmitted. Additionally, the BS may transmit signaling to the UE indicating the pattern for the PRS. The UE may determine the PRS pattern based, at least in part, on the received indication.

### CLAIM OF PRIORITY UNDER 35 U.S.C. §119

The present application for patent claims priority to U.S. Provisional Application No. 61/647,475, entitled METHODS AND APPARATUS FOR POSITIONING REFERENCE SIGNALS IN A NEW CARRIER TYPE, filed May 15, 2012, and assigned to the assignee hereof and hereby expressly incorporated by reference herein.

### FIELD

The present disclosure relates generally to communication systems, and more particularly, to a method and apparatus for positioning reference signals in a new carrier type.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced (LTE/LTE-A) is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Certain aspects of the present disclosure provide a method for wireless communications by a user equipment (UE). The method generally includes identifying a carrier type in which position reference signals (PRS) will be transmitted, and determining a pattern for the PRS, wherein the pattern is based on the carrier type.

Certain aspects of the present disclosure provide an apparatus for wireless communications by a UE. The apparatus generally includes means for identifying a carrier type in which PRS will be transmitted, and means for determining a pattern for the PRS, wherein the pattern is based on the carrier type.

Certain aspects of the present disclosure provide an apparatus for wireless communications by a UE. The apparatus generally includes at least one processor and a memory coupled to the at least one processor. The at least one processor is generally configured to identify a carrier type in which PRS will be transmitted, and determine a pattern for the PRS based on the carrier type.

Certain aspects of the present disclosure provide a computer program product for wireless communications by a UE. The computer program product generally includes a computer-readable medium having code for identifying a carrier type in which position reference signals (PRS) will be transmitted, and determining a pattern for the PRS, wherein the pattern is based on the carrier type.

Certain aspects of the present disclosure provide a method for wireless communications by a base station (BS). The method generally includes identifying a carrier type in which position reference signals (PRS) will be transmitted, determining a pattern for the PRS based on the carrier type, and transmitting signaling indicating the pattern for the PRS.

Certain aspects of the present disclosure provide an apparatus for wireless communications by a base station. The apparatus generally includes means for identifying a carrier type in which PRS will be transmitted, means for determining a pattern for the PRS based on the carrier type, and means for transmitting signaling indicating the pattern for the PRS.

Certain aspects of the present disclosure provide an apparatus for wireless communications by a base station. The apparatus generally includes at least one processor and a memory coupled to the at least one processor. The at least one processor is generally configured to identify a carrier type in which position reference signals (PRS) will be transmitted, determine a pattern for the PRS based on the carrier type, and transmit signaling indicating the pattern for the PRS.

Certain aspects of the present disclosure provide a computer program product for wireless communications by a base station. The computer program product generally includes a computer-readable medium having code for identifying a carrier type in which PRS will be transmitted, determining a pattern for the PRS based on the carrier type, and transmitting signaling indicating the pattern for the PRS.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIG. 7 illustrates legacy PRS pattern for one and two PBCH antenna ports and four PBCH antenna ports in accordance with certain aspects of the present disclosure.

FIG. 8 illustrates a non-legacy PRS pattern for a normal cyclic prefix (CP) case where PRS occupies symbols (or REs) that were originally designated for CRS in legacy carrier types, in accordance with certain aspects of the present disclosure.

FIG. 9 illustrates a non-legacy PRS pattern for a normal cyclic prefix case where PRS occupies symbols (or REs) that were originally designated for CRS and/or legacy control in legacy carrier types, in accordance with certain aspects of the present disclosure.

FIG. 10 illustrates a non-legacy PRS pattern for an extended cyclic prefix case where PRS occupies all symbols of a subframe, in accordance with certain aspects of the present disclosure.

FIG. 11 illustrates a non-legacy PRS pattern for a normal cyclic prefix case based on a legacy PRS pattern, in accordance with certain aspects of the present disclosure.

FIG. 12 is a flow diagram illustrating operations by a user equipment (UE) for determining a PRS pattern in accordance with certain aspects of the present disclosure.

FIG. 13 is a flow diagram illustrating operations by a base station (BS) for determining a PRS pattern in accordance with certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. LTE refers generally to LTE and LTE-Advanced.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, code, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, flash memory, phase change memory (PCM), CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

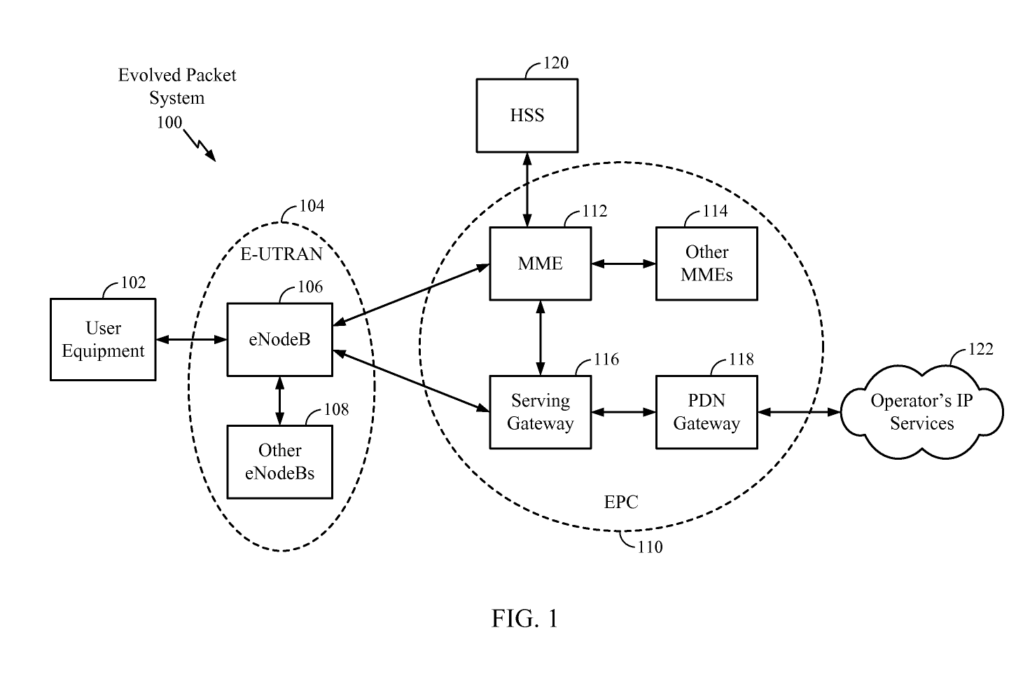

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, an ultrabook, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS (packet-switched) Streaming Service (PSS). In this manner, the UE 102 may be coupled to the PDN through the LTE network.

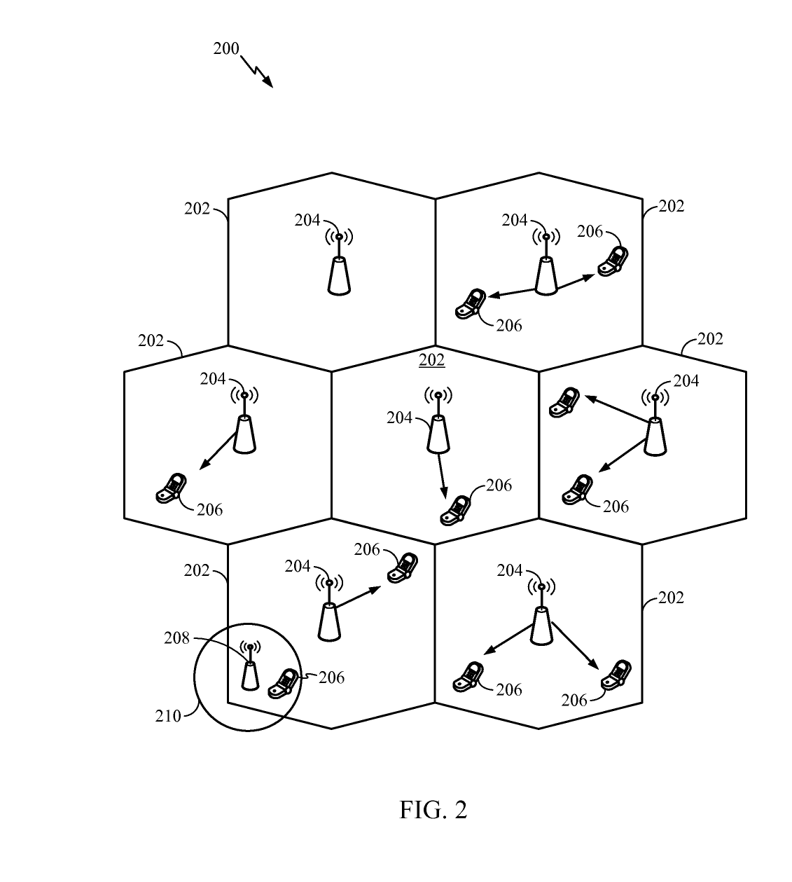

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

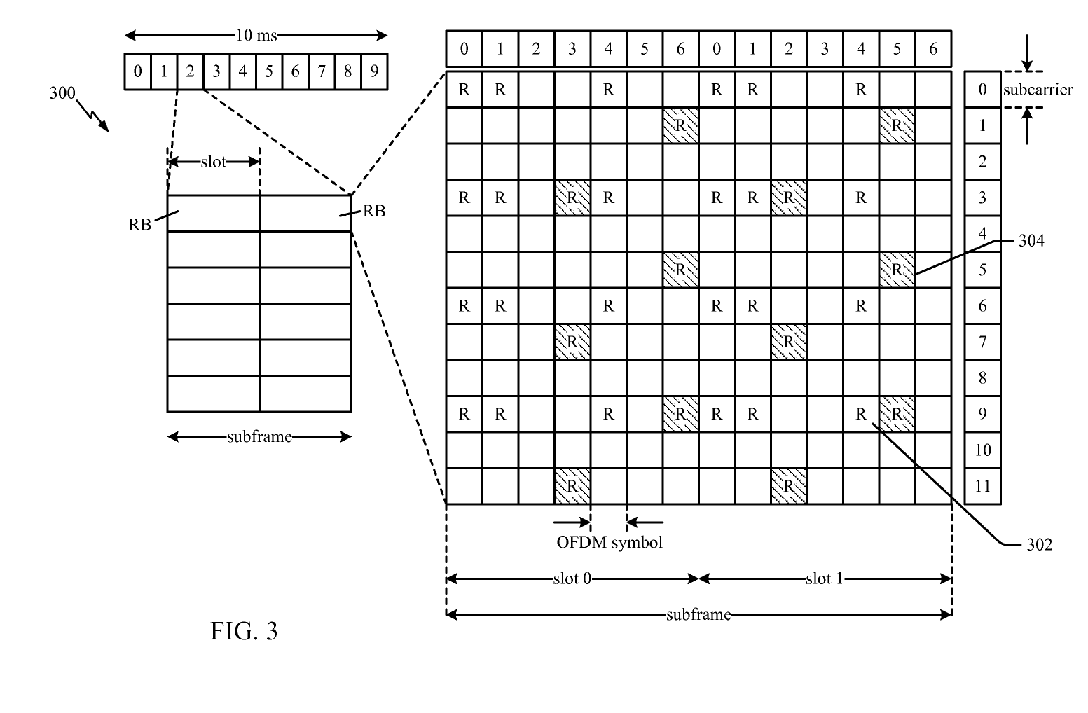

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, R 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

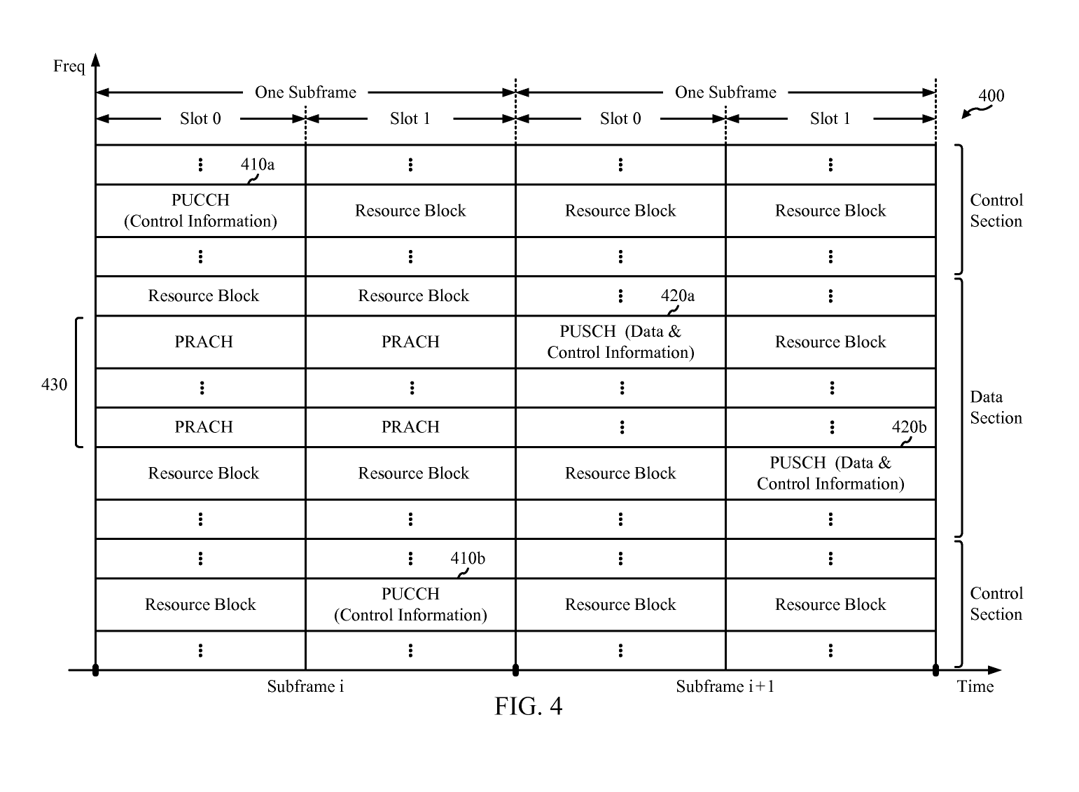

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

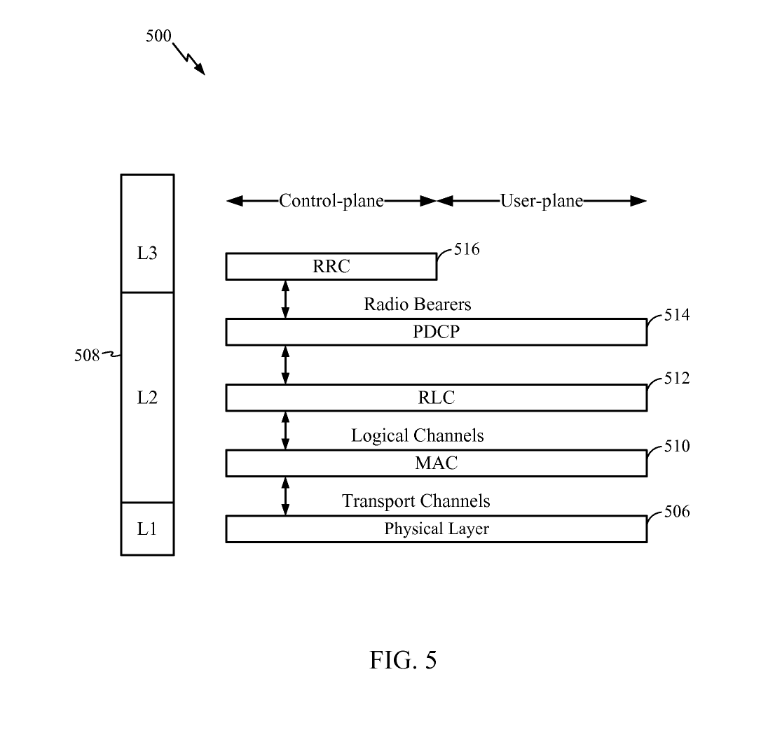

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

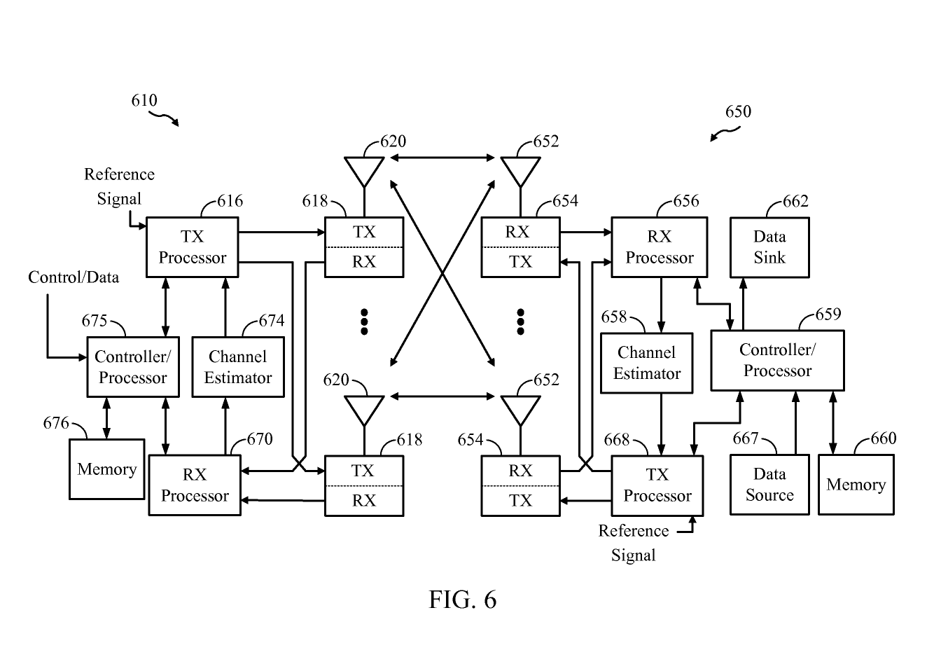

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the control/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

In LTE Rel-8/9/10, Physical Downlink Control Channel (PDCCH) is located in the first several symbols of a subframe. Generally PDCCH are fully distributed in the entire system bandwidth and are time division multiplexed (TDMed) with the Physical Downlink Shared Channel (PDSCH). Effectively, a subframe is divided into a control region and a data region.

In Rel-11 and beyond, a new control channel (e.g., enhanced PDCCH (EPDCCH)) may be introduced. Unlike legacy PDCCH, which occupies the first several control symbols in a subframe, EPDCCH may occupy the data region, similar to PDSCH. EPDCCH messages may span both first and second slots of a subframe (e.g. Frequency Division Duplex (FDD) based EPDCCH). In certain aspects, EPDCCH may help increase control channel capacity, support frequency-domain Inter Cell Interference Coordination (ICIC), achieve improved spatial reuse of control channel resource, support beamforming and/or diversity, operate on the new carrier type and in MBSFN subframes and coexist on the same carrier as legacy UEs.

In LTE Rel-9 and 10, positioning reference signals (PRS) are supported. In certain aspects, for both normal cyclic prefix (CP) and extended CP, PRS is present in all symbols except those used for legacy control and common reference signal (CRS). The pattern of PRS generally exhibits a “diagonal” property, but omits the symbols containing CRS and other legacy control signals. As an example, for normal CP, PRS may not be present in symbol 4 in the first slot and symbols 0 and 4 in the second slot for 1 and 2 CRS ports. As a second example, PRS may not be present in symbol 1 of the second slot for 4 CRS ports.

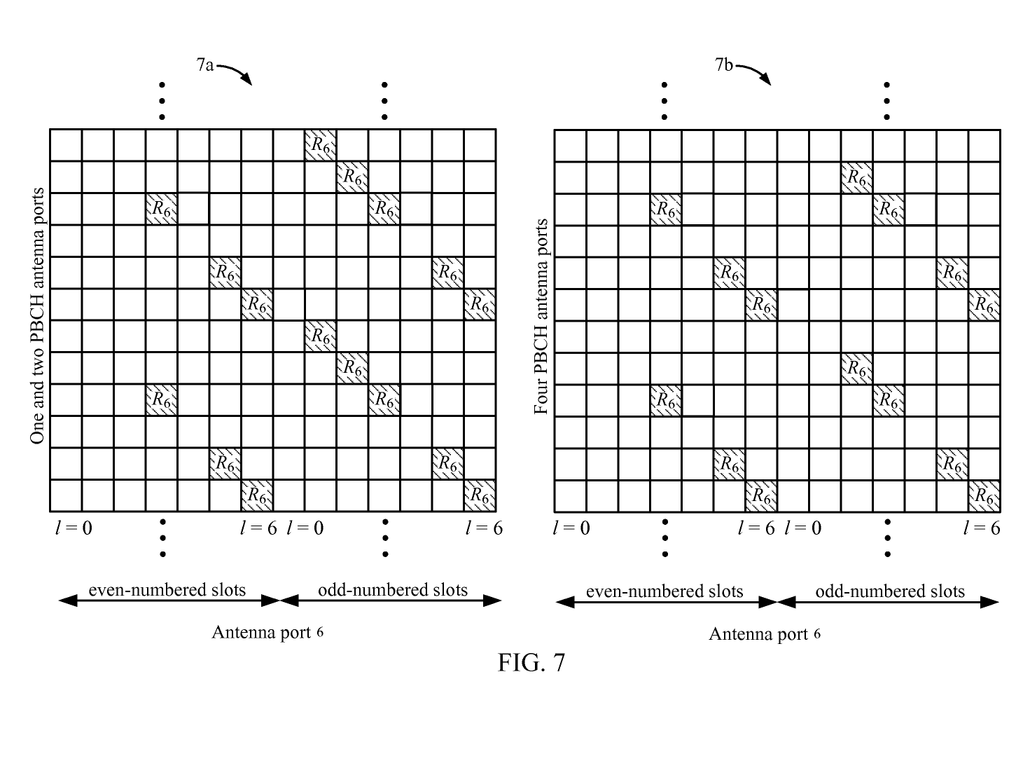

FIG. 7 illustrates legacy PRS pattern for one and two PBCH antenna ports, and four PBCH antenna ports in accordance with certain aspects of the present disclosure. 7a shows a PRS pattern for one and two PBCH antenna ports and 7b shows a PRS pattern for four PBCH antenna ports. In LTE, the PRS are typically transmitted from one antenna port (R6) according to a pre-defined pattern. The squares denoted R₆ in FIGS. 7a and 7b indicate PRS resource elements (REs) within a block of 12 subcarriers over 14 OFDM symbols (1 ms subframe with normal CP).

For the one and two PBCH ports case, as shown in 7a PRS is not present in symbol 4 of the first slot and symbols 0 and 4 in the second slot. For the four PBCH ports case, as shown in 7b, PRS is not present in symbol 1 of the second slot.

In certain aspects, PRS is only transmitted in resource blocks (RB) of downlink subframes configured for PRS transmission. Generally, the periodicity (e.g., 160, 320, 640, or 1280 ms) T_{PRS} and subframe offset Δ_{PRS} for PRS subframes are configurable on a per cell basis. Further, positioning reference signals are transmitted in N_{PRS} consecutive downlink subframes, where N_{PRS} is configured by higher layers (e.g., 1, 2, 4 or 6 subframes). In certain aspects, the first subframe of the N_{PRS} downlink subframes for PRS transmission instances satisfies the following equation:

(10×n_{f}+└nₛ/2┘−Δ_{PRS}) mod T_{PRS}=0

where n_{f} is the frame index and nₛ is the slot index.

In certain aspects, PRS may be in both Multimedia Broadcast Single Frequency Network (MBSFN) and/or non-MBSFN (normal) subframes. PRS may not be transmitted in special subframes in TDD. Further, PRS may not be mapped to resource elements allocated to PBCH, PSS or SSS. In certain aspects, the transmission bandwidth of PRS is configurable, and may be less than a system bandwidth.

In Rel-12 and beyond, a new carrier type (NCT) may be introduced. The NCT may not necessarily be backward compatible. In certain aspects, the presence of CRS in the NCT is only in a subset of subframes (e.g., present in every 5 subframes) in order to reduce DL overhead, to provide energy savings for eNB, etc. In certain aspects, the presence of CRS is only in a fraction of system bandwidth (e.g., only in 25 RBs of a system bandwidth of 50 RBs). In certain aspects, the number of CRS ports in NCT is fixed to be 1.

In certain aspects, in Rel-12, the NCT needs to be associated with a backward compatible carrier as part of carrier aggregation. A carrier of the NCT may not be a standalone carrier. Such constraint may be relaxed such that a carrier of the NCT may be a standalone carrier.

In certain aspects, the NCT may not have the legacy control region, at least in some subframes (if not in all subframes). The NCT may completely rely on enhanced PDCCH (EPDCCH) (and potentially EPCFICH/EPHICH, etc.) for the necessary control signaling, or control from another carrier.

In certain aspects, PRS may be supported in NCT. However, as noted above, current PRS pattern omits CRS symbols (and legacy control symbols), and the pattern does not cover all the 12 tones in a PRB. This may result in compromised PRS performance for the NCT.

In certain aspects, since CRS is only present in a subset of subframes and/or legacy control region may not be present at least in some subframes, minor changes may be made to the legacy PRS pattern for improved positioning performance for the NCT.

In certain aspects, different PRS patterns may be used based on carrier types. For example, for legacy carrier type, the same PRS pattern as currently defined in Rel-9/10 may be used, and a different PRS pattern may be used for a new carrier type. In certain aspects, a UE may determine a PRS pattern based on whether its carrier is an NCT or legacy carrier type. Alternatively, the PRS pattern to be used may also be signaled (broadcast, multicast, or unicast) to the UE, e.g. by a base station.

In certain aspects, for NCT, the presence of PRS pattern may be constrained only in subframes without CRS, e.g. up to 8 subframes in 10 subframes without CRS.

In certain aspects, if among the N_{PRS} consecutive subframes configured for PRS transmissions, there are one or more subframes containing CRS, the transmission of PRS in these CRS subframes may be omitted. Alternatively, for NCT, depending on whether CRS is present or not, a subframe with CRS may use a PRS pattern (e.g., legacy PRS pattern) different from a subframe without CRS (e.g., new PRS pattern), especially when the N_{PRS} consecutive PRS subframes span both CRS and CRS-less subframes.

In certain aspects, a fixed PRS pattern (e.g., legacy PRS pattern) may be transmitted if there is at least one CRS subframe in the N_{PRS} consecutive subframes configured for PRS transmissions, and a different PRS pattern (e.g., new PRS pattern) may be transmitted if there are no CRS subframes in the N_{PRS} consecutive subframes configured for PRS transmissions

In certain aspects, the new (non-legacy) PRS pattern may consider whether CRS is present or not, and/or, whether legacy control is present or not, and/or may consider a bandwidth of the CRS (e.g., narrow band).

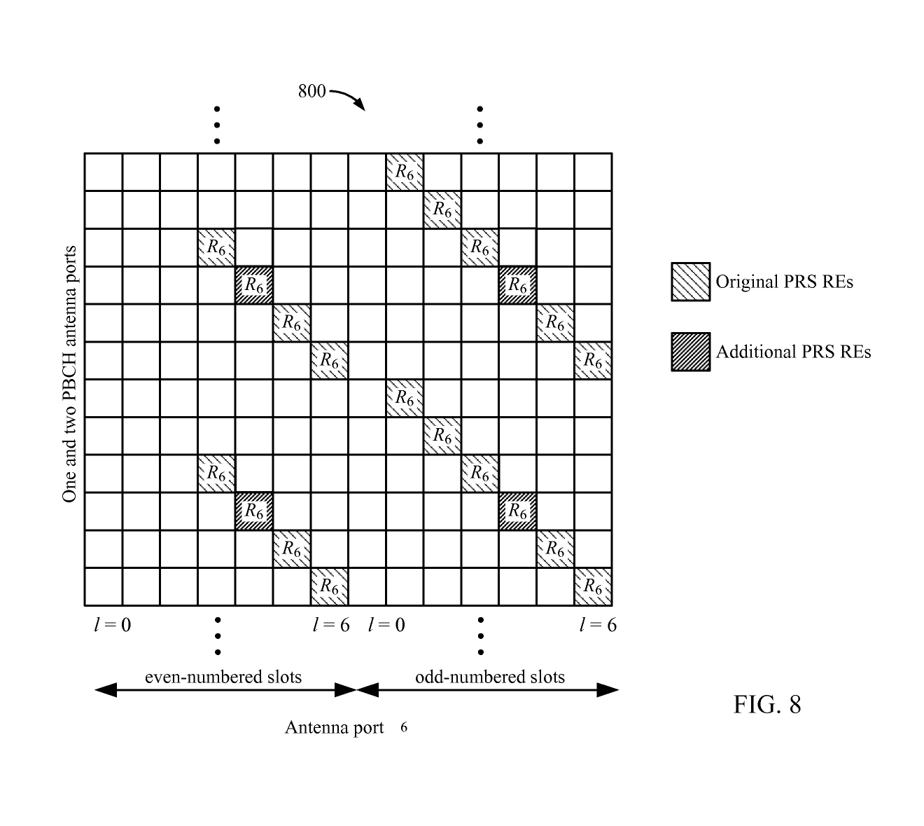

In certain aspects, in the new PRS pattern, PRS may be present in symbols of a subframe originally designated for CRS in legacy carrier types, but no longer contain the CRS in the NCT. For example, FIG. 8 illustrates a non-legacy PRS pattern 800 for a normal cyclic prefix (CP) case where PRS occupies symbols (or REs), denoted by additional PRS REs, that were originally designated for CRS in legacy carrier types, in accordance with certain aspects of the present disclosure. In an aspect, the PRS pattern 800 may form a perfect “diagonal” property. However, it may be noted that not all original CRS symbols may be activated to have PRS REs.

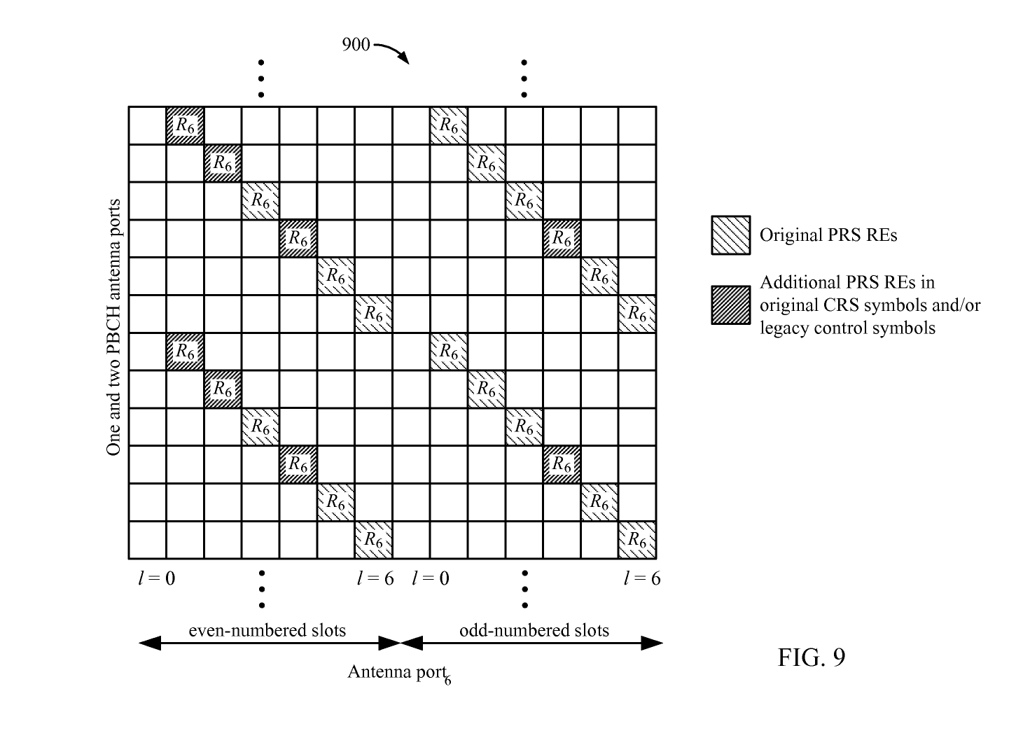

In certain aspects, PRS may be additionally present in symbols originally designated for legacy controls. For example, FIG. 9 illustrates a non-legacy PRS pattern 900 for a normal cyclic prefix case where PRS occupies symbols (or REs), denoted by additional PRS REs, that were originally designated for CRS and/or legacy control in legacy carrier types, in accordance with certain aspects of the present disclosure. In an aspect, as noted with PRS pattern 800, PRS pattern 900 may also form a perfect “diagonal” property. Again, not all legacy control symbols may be activated to PRS REs. For example, as shown in FIG. 9, symbol 0 in both slots may be without PRS.

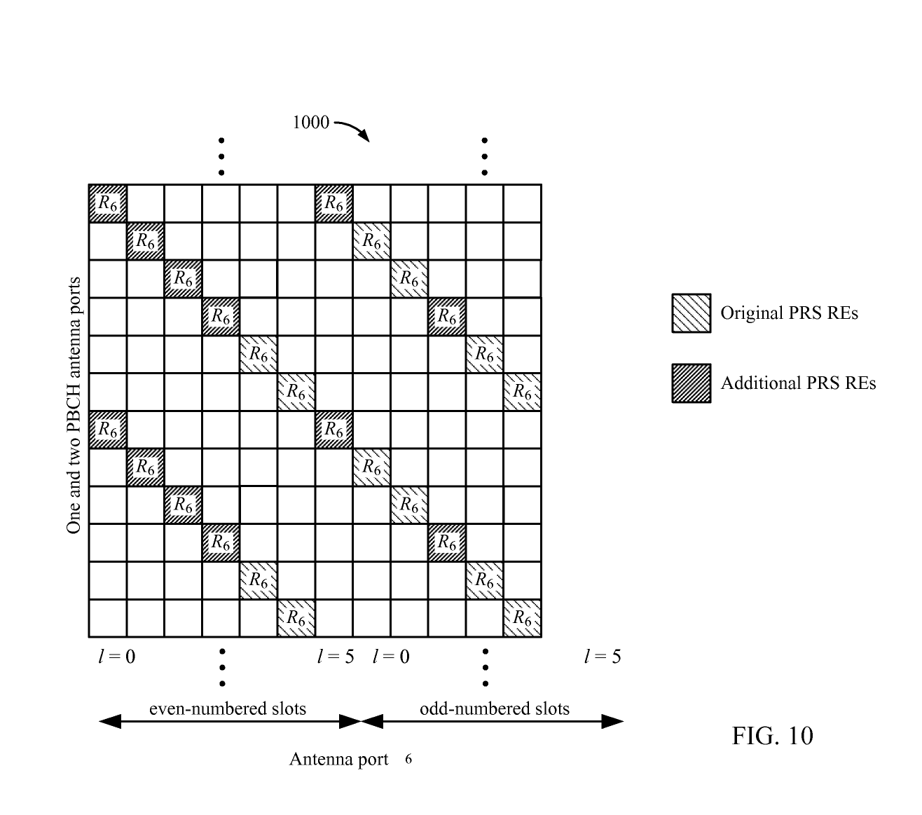

In certain aspects, for an extended CP case, all symbols may carry PRS. For example, FIG. 10 illustrates a non-legacy PRS pattern 1000 for an extended cyclic prefix case where PRS occupies all symbols of a subframe, in accordance with certain aspects of the present disclosure. As shown in FIG. 10, PRS occupies all 12 symbols of the subframe forming a perfect diagonal shape.

In certain aspects, a new (non-legacy) PRS pattern for the NCT may be based on a legacy PRS pattern with certain changes. For example, if (k,l) represents a position of a PRS RE, where k is the tone index and/is the symbol index, the new PRS pattern may add an offset Δ to the definition of k for one or more PRS REs. For example, k and/for legacy PRS patterns may be given by:

$$k = 6 ( m + {N}_{RB}^{DL} - {N}_{RB}^{PRS} ) + ( 6 - l + {v}_{shift} ) mod 6$$

$$l = \{ \begin{matrix}3 , 5 , 6 & if {n}_{s} mod 2 = 0 \\ 1 , 2 , 3 , 5 , 6 & if {n}_{s} mod 2 = 1 and ( 1 or 2 PBCH antenna ports ) \\ 2 , 3 , 5 , 6 & if {n}_{s} mod 2 = 1 and ( 4 PBCH antenna ports )\end{matrix} \\ m = 0 , 1 , … , 2 \cdot {N}_{RB}^{PRS} - 1 \\ {m}^{′} = m + {N}_{RB}^{max , DL} - {N}_{RB}^{PRS}$$

Adding an offset Δ to the definition of k, the above may be modified as:

$$k = 6 ( m + {N}_{RB}^{DL} - {N}_{RB}^{PRS} ) + ( 6 - l + Δ + {v}_{shift} ) mod 6$$

$$l = \{ \begin{matrix}3 , 5 , 6 & if {n}_{s} mod 2 = 0 \\ 1 , 2 , 3 , 5 , 6 & if {n}_{s} mod 2 = 1 and ( 1 or 2 PBCH antenna ports ) \\ 2 , 3 , 5 , 6 & if {n}_{s} mod 2 = 1 and ( 4 PBCH antenna ports )\end{matrix} \\ Δ = \{ \begin{matrix}1 & if {n}_{s} mod 2 = 1 and l = 5 \\ 0 & otherwise\end{matrix} \\ m = 0 , 1 , … , 2 \cdot {N}_{RB}^{PRS} - 1 \\ {m}^{′} = m + {N}_{RB}^{max , DL} - {N}_{RB}^{PRS}$$

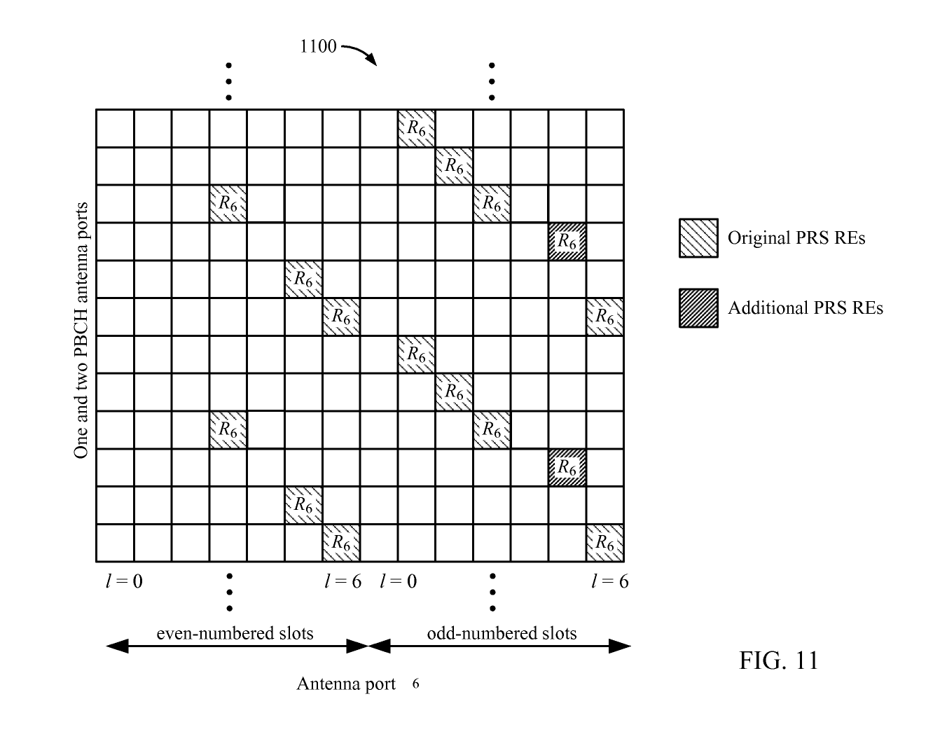

For example, FIG. 11 illustrates a non-legacy PRS pattern 1100 for a normal cyclic prefix case based on a legacy PRS pattern, in accordance with certain aspects of the present disclosure. As shown in FIG. 11, the additional PRS REs have their tone index shifted by an offset Δ from their legacy positions.

For NCT, the bandwidth of the CRS (e.g., 1-port CRS) may be the same as the system bandwidth, or may be smaller than the system bandwidth. In certain aspects, in a subframe containing CRS (e.g., 1-port CRS) in NCT, if the CRS bandwidth is smaller than the system bandwidth and the PRB bandwidth, the PRS pattern for the subframe is the same regardless of the presence/absence of CRS in a PRB. Alternatively, the PRS pattern can be PRB-dependent, e.g., a first pattern is used if a PRB contains CRS, while a second pattern is used if a PRB does not contain CRS in the same subframe.

In certain aspects, it may also be desirable to keep the new PRS pattern that contains a set of REs which are a superset of the REs for the legacy PRS pattern, such that a new UE may take it as the new PRS pattern and a legacy UE may take it as the legacy PRS pattern. In an aspect, the legacy UE may not be aware of any new additional REs specified for the new PRS pattern.

In certain aspects, when PDSCH and PRS are in the same RB, PDSCH is typically dropped (e.g. as stated in 36.213), for example since low reuse PRS is important for deep penetration of PRS.

Similarly, it may be expected that EPDCCH does not co-exist with PRS in the same RB. However, it may be difficult to ensure such a condition, since the EPDCCH resource configured for a UE may have to consider both PRS and non-PRS subframes. For example, if PRS has a bandwidth smaller than the system bandwidth, where EPDCCH may still be frequency division multiplexed (FDMed) with PRS in the same subframe, an EPDCCH resource configuration good for non-PRS subframes may not be good for the PRS subframes, especially when distributed EPDCCH resource is configured.

As a result, in certain aspects, two different EPDCCH resource configurations may be allowed, one for a first subframe type (e.g., without PRS), and another for a second subframe type (e.g., with PRS).

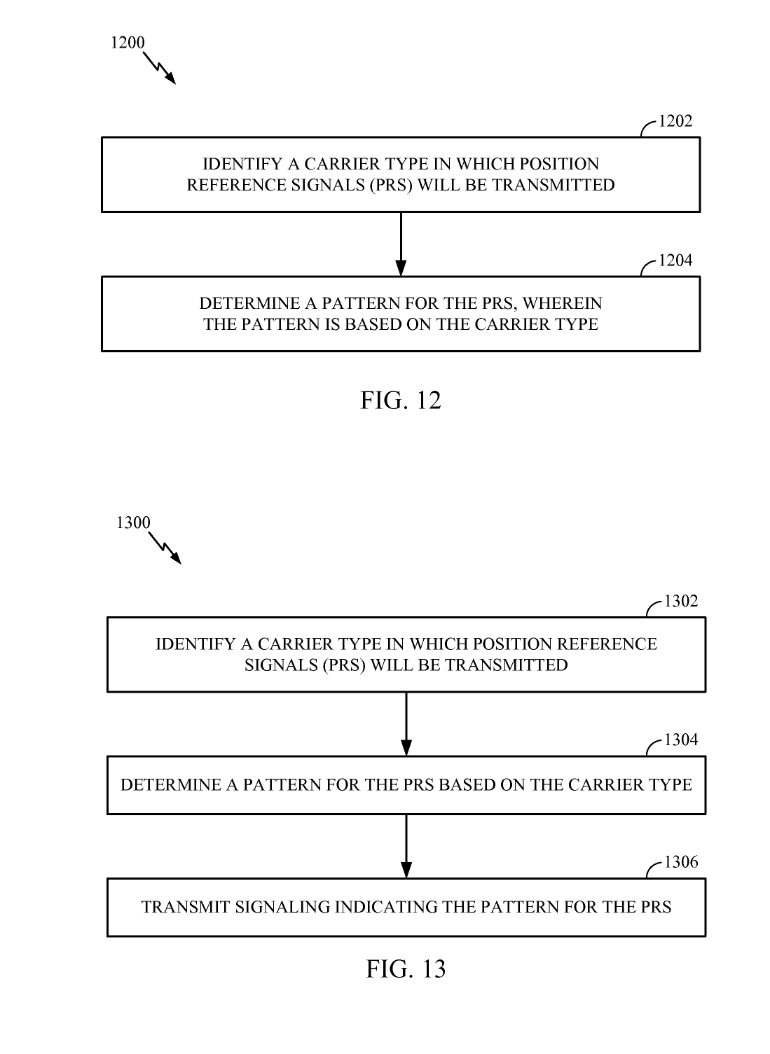

FIG. 12 is a flow diagram illustrating operations 1200 by a user equipment (UE) for determining a PRS pattern in accordance with certain aspects of the present disclosure. Operations 1200 may begin at 1202 by identifying a carrier type in which position reference signals (PRS) will be transmitted. At 1204, the UE may determine a pattern for the PRS based on the identified carrier type.

In certain aspects, at least a first PRS pattern may be used for a legacy carrier type compatible with a first type of UEs, and at least a second PRS pattern may be used for a new carrier type compatible with a second type of UEs and not compatible with the first type of UEs. In an aspect REs of the second PRS pattern may be present in more symbols in a subframe than REs of the first PRS pattern. In an aspect, REs of the second PRS pattern may occupy symbols used for control in the legacy carrier type.

In certain aspects, the second PRS pattern may be formed by shifting tones of one or more REs of the first PRS pattern.

In certain aspects, REs of the second PRS pattern may include a superset of REs of the first PRS pattern. In an aspect, the second PRS pattern transmitted by a carrier may be received as the second PRS pattern by the second type of UE and may be received as the first PRS pattern by the first type of UEs.

In certain aspects, REs of the second PRS pattern may be present in each symbol in a subframe. In certain aspects, REs of the second PRS pattern may be present at each tone in a resource block of a subframe.

In certain aspects, the UE may receive signaling indicating the PRS pattern and may determine the PRS pattern based on the received indication. In certain aspects, PRS may be transmitted in consecutive subframes and PRS may be omitted from subframes containing CRS. In certain aspects, a first PRS pattern may be used if CRS is transmitted in any of the consecutive subframes and a second PRS pattern may be used if CRS is not transmitted in any of the consecutive subframes.

In certain aspects, different patterns of PRS may be used for different subframes depending on whether or not CRS is transmitted. In certain aspects, different PRS patterns may be used for different subframes depending on whether or not legacy control signals are transmitted.

In certain aspects, the PRS may be transmitted in a subframe containing CRS, and different patterns of the PRS may be used for different resource blocks in the subframe depending on whether or not CRS is transmitted in each of the resource blocks.

In certain aspects, different resource configurations may be used for an EPDCCH depending on whether or not PRS is transmitted in a subframe.

FIG. 13 is a flow diagram illustrating operations 1300 by a base station (BS) for determining a PRS pattern in accordance with certain aspects of the present disclosure. Operations 1300 may begin at 1302 by identifying a carrier type in which PRS will be transmitted. At 1304, a pattern for the PRS may be determined based on the carrier type. At 1306, signaling indicating the pattern for the PRS may be transmitted.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined, in parallel, or omitted. The accompanying method claims present elements of the various steps in a sample order, and are not meant to be limited to the specific order or hierarchy presented.

As used herein, a phrase referring to “at least one of” a list of items refers to any combination of those items, including single members. As an example, “at least one of: a, b, or c” is intended to cover: a, b, c, a-b, a-c, b-c, and a-b-c. The term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded their full scope. Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method for wireless communications by a user equipment (UE), comprising:
identifying a carrier type in which position reference signals (PRS) will be transmitted; and
determining a pattern for the PRS, wherein the pattern is based on the carrier type.

2. The method of claim 1, wherein:
at least a first PRS pattern is used for a legacy carrier type compatible with a first type of UEs; and
at least a second PRS pattern is used for a new carrier type compatible with a second type of UEs and not compatible with the first type of UEs.

3. The method of claim 2, wherein resource elements (REs) of the second PRS pattern are present in more symbols in a subframe than REs of the first PRS pattern.

4. The method of claim 3, wherein REs of the second PRS pattern occupy symbols used for control in the legacy carrier type.

5. The method of claim 2, wherein the second PRS pattern is formed by shifting tones of one or more REs of the first PRS pattern.

6. The method of claim 3, wherein REs of the second PRS pattern comprise a superset of REs of the first PRS pattern.

7. The method of claim 6, wherein the second PRS pattern transmitted by a carrier is received as the second PRS pattern by the second type of UE and is received as the first PRS pattern by the first type of UEs.

8. The method of claim 2, wherein REs of the second PRS pattern are present in each symbol in a subframe.

9. The method of claim 2, wherein REs of the second PRS pattern are present at each tone in a resource block of a subframe.

10. The method of claim 1, wherein the determining comprises receiving signaling indicating the PRS pattern.

11. The method of claim 1, wherein the determining comprises determining the PRS pattern, by the UE, based on the carrier type.

12. The method of claim 1, wherein:
PRS is transmitted in consecutive subframes; and
PRS is omitted from subframes containing common reference signals (CRS).

13. The method of claim 1, wherein:
different patterns of PRS are used for different subframes depending on whether or not common reference signals (CRS) is transmitted.

14. The method of claim 1, wherein:
PRS is transmitted in consecutive subframes; and
a first PRS pattern is used if CRS is transmitted in any of the consecutive subframes and a second PRS pattern is used if CRS is not transmitted in any of the consecutive subframes.

15. The method of claim 1, wherein:
different patterns of PRS are used for different subframes depending on whether or not legacy control signals are transmitted.

16. The method of claim 1, wherein:
the PRS is transmitted in a subframe containing common reference signals (CRS); and
different patterns of the PRS are used for different resource blocks in the subframe depending on whether or not CRS is transmitted in each of the resources blocks.

17. The method of claim 1, wherein:
different resource configurations are used for an enhanced physical downlink control channel (EPDCCH) depending on whether or not PRS is transmitted in a subframe.

18. An apparatus for wireless communications, comprising:
means for identifying a carrier type in which position reference signals (PRS) will be transmitted; and
means for determining a pattern for the PRS, wherein the pattern is based on the carrier type.

19. The apparatus of claim 18, wherein:
at least a first PRS pattern is used for a legacy carrier type compatible with a first type of UEs; and
at least a second PRS pattern is used for a new carrier type compatible with a second type of UEs and not compatible with the first type of UEs.

20. The apparatus of claim 19, wherein resource elements (REs) of the second PRS pattern are present in more symbols in a subframe than REs of the first PRS pattern.

21. The apparatus of claim 20, wherein REs of the second PRS pattern occupy symbols used for control in the legacy carrier type.

22. The apparatus of claim 19, wherein the second PRS pattern is formed by shifting tones of one or more REs of the first PRS pattern.

23. The apparatus of claim 20, wherein REs of the second PRS pattern comprise a superset of REs of the first PRS pattern.

24. The apparatus of claim 23, wherein the second PRS pattern transmitted by a carrier is received as the second PRS pattern by the second type of UE and is received as the first PRS pattern by the first type of UEs.

25. The apparatus of claim 19, wherein REs of the second PRS pattern are present in each symbol in a subframe.

26. The apparatus of claim 19, wherein REs of the second PRS pattern are present at each tone in a resource block of a subframe.

27. The apparatus of claim 18, wherein the means for determining is configured to receive signaling indicating the PRS pattern.

28. The apparatus of claim 18, wherein:
PRS is transmitted in consecutive subframes; and
PRS is omitted from subframes containing common reference signals (CRS).

29. The apparatus of claim 18, wherein:
different patterns of PRS are used for different subframes depending on whether or not common reference signals (CRS) is transmitted.

30. The apparatus of claim 18, wherein:
PRS is transmitted in consecutive subframes; and
a first PRS pattern is used if CRS is transmitted in any of the consecutive subframes and a second PRS pattern is used if CRS is not transmitted in any of the consecutive subframes.

31. The apparatus of claim 18, wherein:
different patterns of PRS are used for different subframes depending on whether or not legacy control signals are transmitted.

32. The apparatus of claim 18, wherein:
the PRS is transmitted in a subframe containing common reference signals (CRS); and
different patterns of the PRS are used for different resource blocks in the subframe depending on whether or not CRS is transmitted in each of the resources blocks.

33. The apparatus of claim 18, wherein:
different resource configurations are used for an enhanced physical downlink control channel (EPDCCH) depending on whether or not PRS is transmitted in a subframe.

34. An apparatus for wireless communications, comprising:
at least one processor configured to:
identify a carrier type in which position reference signals (PRS) will be transmitted; and
determine a pattern for the PRS, wherein the pattern is based on the carrier type; and
a memory coupled to the at least one processor.

35. A computer program product comprising:
a computer-readable medium having code for:
identifying a carrier type in which position reference signals (PRS) will be transmitted; and
determining a pattern for the PRS, wherein the pattern is based on the carrier type.

36. A method for wireless communications by a base station (BS), comprising:
identifying a carrier type in which position reference signals (PRS) will be transmitted;
determining a pattern for the PRS based on the carrier type; and
transmitting signaling indicating the pattern for the PRS.

37. The method of claim 36, wherein:
at least a first PRS pattern is used for a legacy carrier type compatible with a first type of UEs; and
at least a second PRS pattern is used for a new carrier type compatible with a second type of UEs and not compatible with the first type of UEs.

38. The method of claim 37, wherein resource elements (REs) of the second PRS pattern are present in more symbols in a subframe than REs of the first PRS pattern.

39. The method of claim 38, wherein REs of the second PRS pattern occupy symbols used for control in the legacy carrier type.

40. The method of claim 37, wherein the second PRS pattern is formed by shifting tones of one or more REs of the first PRS pattern.

41. The method of claim 38, wherein REs of the second PRS pattern comprise a superset of REs of the first PRS pattern.

42. The method of claim 37, wherein REs of the second PRS pattern are present in each symbol in a subframe.

43. The method of claim 37, wherein REs of the second PRS pattern are present at each tone in a resource block of a subframe.

44. The method of claim 36, wherein:
PRS is transmitted in consecutive subframes; and
PRS is omitted from subframes containing common reference signals (CRS).

45. The method of claim 36, wherein:
different patterns of PRS are used for different subframes depending on whether or not common reference signals (CRS) is transmitted.

46. The method of claim 36, wherein:
PRS is transmitted in consecutive subframes; and
a first PRS pattern is used if CRS is transmitted in any of the consecutive subframes and a second PRS pattern is used if CRS is not transmitted in any of the consecutive subframes.

47. The method of claim 36, wherein:
different patterns of PRS are used for different subframes depending on whether or not legacy control signals are transmitted.

48. The method of claim 36, wherein:
different resource configurations are used for an enhanced physical downlink control channel (EPDCCH) depending on whether or not PRS is transmitted in a subframe.

49. An apparatus for wireless communications comprising:
means for identifying a carrier type in which position reference signals (PRS) will be transmitted;
means for determining a pattern for the PRS based on the carrier type; and
means for transmitting signaling indicating the pattern for the PRS.

50. The apparatus of claim 49, wherein:
at least a first PRS pattern is used for a legacy carrier type compatible with a first type of UEs; and
at least a second PRS pattern is used for a new carrier type compatible with a second type of UEs and not compatible with the first type of UEs.

51. The apparatus of claim 50, wherein resource elements (REs) of the second PRS pattern are present in more symbols in a subframe than REs of the first PRS pattern.

52. The apparatus of claim 51, wherein REs of the second PRS pattern occupy symbols used for control in the legacy carrier type.

53. The apparatus of claim 50, wherein the second PRS pattern is formed by shifting tones of one or more REs of the first PRS pattern.

54. The apparatus of claim 51, wherein REs of the second PRS pattern comprise a superset of REs of the first PRS pattern.

55. The apparatus of claim 50, wherein REs of the second PRS pattern are present in each symbol in a subframe.

56. The apparatus of claim 50, wherein REs of the second PRS pattern are present at each tone in a resource block of a subframe.

57. The apparatus of claim 49, wherein:
PRS is transmitted in consecutive subframes; and
PRS is omitted from subframes containing common reference signals (CRS).

58. The apparatus of claim 49, wherein:
different patterns of PRS are used for different subframes depending on whether or not common reference signals (CRS) is transmitted.

59. The apparatus of claim 49, wherein:
PRS is transmitted in consecutive subframes; and
a first PRS pattern is used if CRS is transmitted in any of the consecutive subframes and a second PRS pattern is used if CRS is not transmitted in any of the consecutive subframes.

60. The apparatus of claim 49, wherein:
different patterns of PRS are used for different subframes depending on whether or not legacy control signals are transmitted.

61. The apparatus of claim 49, wherein:
different resource configurations are used for an enhanced physical downlink control channel (EPDCCH) depending on whether or not PRS is transmitted in a subframe.

62. An apparatus for wireless communications comprising:
at least one processor configured to:
identify a carrier type in which position reference signals (PRS) will be transmitted;
determine a pattern for the PRS based on the carrier type; and
transmit signaling indicating the pattern for the PRS; and
a memory coupled to the at least one processor.

63. A computer program product for wireless communications comprising:
a computer-readable medium having code for:
identifying a carrier type in which position reference signals (PRS) will be transmitted;
determining a pattern for the PRS based on the carrier type; and
transmitting signaling indicating the pattern for the PRS.
